(19) United States
(12) Patent Application Publication
(10) Pub. No.: US 2026/0340976 A1
(43) Pub. Date: Oct. 29, 2026

(54) SENSOR DATA OCCLUSION LOCALIZATION

(71) Applicant: Ford Global Technologies, LLC, Dearborn, MI (US)

(72) Inventors: Ali Hassani, Ann Arbor, MI (US); Robert Schroeter, Livonia, MI (US)

(73) Assignee: Ford Global Technologies, LLC, Dearborn, MI (US)

(21) Appl. No.: 19/192,478

(22) Filed: Apr. 29, 2025

(51) Int. Cl. G06V 10/26; G06T 7/73; G06V 10/764; G06V 10/80; G06V 20/56

(52) U.S. Cl. CPC G06V 10/26; G06T 7/73; G06V 10/764; G06V 10/806; G06V 20/56; G06T 2207/30168; G06T 2207/30192; G06T 2207/30252

(57) ABSTRACT

A computer includes a processor and a memory, and the memory stores instructions executable by the processor to detect features in sensor data from an imaging sensor and execute a transformer on the features. The transformer transforms the features to a birds-eye view embedding space, classifies an occlusion from the features, and outputs a spatial location of the occlusion. The transformer is trained to classify occlusions and is not trained to classify objects.

### BACKGROUND

Vehicles typically include a variety of sensors. The sensors may provide data about operation of the vehicle, for example, wheel speed, wheel orientation, and engine and transmission data (e.g., temperature, fuel consumption, etc.). The sensors may detect the location and/or orientation of the vehicle. The sensors can include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors may detect the external world, including objects and/or characteristics of surroundings of the vehicle, such as other vehicles, road lane markings, traffic lights and/or signs, road users, etc. The sensors can include radar sensors, ultrasonic sensors, scanning laser range finders, light detection and ranging (lidar) devices, and image processing sensors such as cameras.

### BRIEF DESCRIPTION OF THE DRAWINGS

FIG. 1 is a block diagram of an example vehicle.

FIG. 2 is a rear view from an interior of the vehicle through a windshield of the vehicle.

FIG. 3 is a diagram of occlusions in a birds-eye view embedding space.

FIG. 4 is diagram of an example machine-learning architecture installed on the vehicle for analyzing occlusions.

FIG. 5 is a flowchart of an example process for analyzing the occlusions and actuating the vehicle.

### DETAILED DESCRIPTION

This disclosure provides techniques for addressing occlusions that affect sensor data from an imaging sensor. For example, the imaging sensor may be a camera mounted to a vehicle, the sensor data may be an image, and types of occlusions may include rain, fog, debris on the camera lens, etc. A computer may be programmed to detect features in the sensor data from the imaging sensor and execute a transformer on the features. The transformer transforms the features to a birds-eye view embedding space, classifies an occlusion from the features, and outputs a spatial location of the occlusion. The transformer is trained to classify occlusions and is not trained to classify objects.

Classifying an anomaly can help mitigate the anomaly. A component of the vehicle may be actuated based on the classification, such as windshield wipers in response to rain, a cleaning nozzle in response to debris on the camera lens, etc. The spatial location can also help mitigate the anomaly, such as by activating the windshield wipers before entering rain. Training only for occlusions and not for objects keeps the volume of training within reasonable bounds. Moreover, identifying occlusions may be used for actuating different components of the vehicle than identifying objects. Identifying occlusions may be used for actuating components related to cleaning and clearing the field of view, such as windshield wipers, nozzles for the imaging sensor, etc. Identifying objects may instead be used for controlling the motion of the vehicle.

A computer includes a processor and a memory, and the memory stores instructions executable by the processor to detect features in sensor data from an imaging sensor and execute a transformer on the features. The transformer transforms the features to a birds-eye view embedding space, classifies an occlusion from the features, and outputs a spatial location of the occlusion. The transformer is trained to classify occlusions and is not trained to classify objects.

In an example, the instructions may further include instructions to actuate a component based on the spatial location of the occlusion. In a further example, a vehicle may include the imaging sensor and the component.

In an example, the instructions may further include instructions to actuate a component based on the classification of the occlusion.

In an example, the imaging sensor may be a camera, and the sensor data may be image data. In a further example, the transformer may be programmed to fuse the features from the image data with range data from at least one range sensor in the birds-eye view embedding space. In a still further example, the instructions may further include instructions to project the features to an initial spatial location of the occlusion in the birds-eye view embedding space, and the transformer may be programmed to correct the initial spatial location of the occlusion with the range data to the spatial location.

In another still further example, the instructions may further include instructions to rasterize the range data before the transformer fuses the features and the range data.

In another still further example, the at least one range sensor may include at least one of a lidar or a radar.

In another still further example, the at least one range sensor may include a lidar and a radar.

In an example, the spatial location may be specified in at least two horizontal dimensions.

In an example, the instructions to classify the occlusion may include instructions to select a type from a predetermined set of potential types. In a further example, the predetermined set of potential types may include at least two of rain, fog, dirt on the imaging sensor, or bug on the imaging sensor.

A method includes detecting features in sensor data from an imaging sensor and executing a transformer on the features. The transformer transforms the features to a birds-eye view embedding space, classifies an occlusion from the features, and outputs a spatial location of the occlusion. The transformer is trained to classify occlusions and is not trained to classify objects.

In an example, the method may further include actuating a component based on the spatial location of the occlusion, wherein a vehicle includes the imaging sensor and the component.

In an example, the method may further include actuating a component based on the classification of the occlusion, wherein a vehicle includes the imaging sensor and the component.

In an example, the transformer may be programmed to fuse the features with range data from at least one range sensor in the birds-eye view embedding space. In a further example, the transformer may be programmed to correct the spatial location of the occlusion with the range data.

In another further example, the method may further include rasterizing the range data before the transformer fuses the features and the range data.

In an example, classifying the occlusion includes selecting a type from a predetermined set of potential types, and the predetermined set of potential types includes at least two of rain, fog, dirt on the imaging sensor, or bug on the imaging sensor.

With reference to the Figures, wherein like numerals indicate like parts throughout the several views, a computer 105 includes a processor and a memory, and the memory stores instructions executable by the processor to detect features in sensor data 405 from an imaging sensor 110 and execute a transformer 410 on the features. The transformer 410 transforms the features to a birds-eye view embedding space 300, classifies an occlusion 205 from the features, and outputs a spatial location of the occlusion 205. The transformer 410 is trained to classify occlusions 205 and is not trained to classify objects.

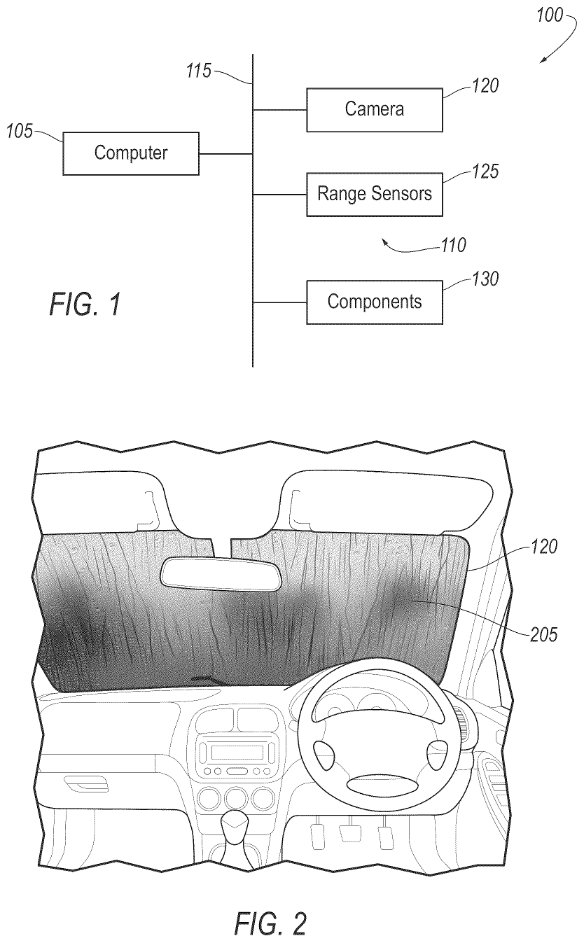

With reference to FIG. 1, a vehicle 100 may be any passenger or commercial automobile such as a car, a truck, a sport utility vehicle, a crossover, a van, a minivan, a taxi, a bus, etc. Alternatively, the vehicle 100 may be a different mode of transportation such as a boat, train, airplane, helicopter, flying taxi, unmanned aerial vehicle (UAV) (e.g., a drone), etc. The vehicle 100 may include the computer 105, a communications network 115, the imaging sensors 110 (e.g., camera(s) 120 and/or range sensor(s) 125), and actuatable components 130.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 115. The communications network 115 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the imaging sensors 110, the actuatable components 130, and other components via the communications network 115.

The imaging sensors 110 detect the external world, including objects and/or characteristics of surroundings of the vehicle 100, such as other vehicles, road lane markings, traffic lights and/or signs, road users, etc. The imaging sensors 110 may include at least one camera 120 and/or at least one range sensor 125. The imaging sensors 110 are mounted to the vehicle 100. The imaging sensors 110 may thus be provided with a field of view of a portion of the surroundings of the vehicle 100.

The cameras 120 can detect electromagnetic radiation in some range of wavelengths. For example, the cameras 120 may detect visible light, infrared radiation, ultraviolet light, or some range of wavelengths including visible, infrared, and/or ultraviolet light. For example, the cameras 120 can be charge-coupled devices (CCD), complementary metal oxide semiconductors (CMOS), or any other suitable type. For another example, the cameras 120 may be a time-of-flight (TOF) cameras 120, which include a modulated light source for illuminating the environment and detect both reflected light from the modulated light source and ambient light to sense reflectivity amplitudes and distances to the scene. For another example, the cameras 120 may be stereo cameras 120, in which the parallax between two cameras 120 provides an estimate of three-dimensional positions of features of the environment.

The range sensors 125 may include at least one lidar, at least one radar, and/or at least one ultrasonic sensor. The radar transmits radio waves and receives reflections of those radio waves to detect physical objects in the environment. The radar can use direct propagation (i.e., measuring time delays between transmission and reception of radio waves) and/or indirect propagation (i.e., Frequency Modulated Continuous Wave (FMCW) method, that is, measuring changes in frequency between transmitted and received radio waves). The lidar detects distances to objects by emitting laser pulses at a particular wavelength and measuring the time of flight for the pulse to travel to the object and back. The lidar can be any suitable type for providing the lidar data on which the computer 105 can act, such as spindle-type lidar, solid-state lidar, flash lidar, etc. The ultrasonic sensor measures distances to features of the environment by emitting ultrasonic sound waves and converting the reflected sound into an electrical signal.

The components 130 are parts of the vehicle 100 that are capable of being actuated according to an instruction from the computer 105 via the communications network 115. In the context of the present disclosure, “actuating” is defined as setting an object into motion or action via a mechanical or electromechanical stimulus. For example, the components 130 may include windshield wipers, headlamps, fog lamps, pumps and/or valves for providing washer fluid or pressurized airflow to a windshield 210 or to one of the imaging sensors 110, etc.

With reference to FIG. 2, an occlusion 205 is something in the field of view of one of the imaging sensors 110 that obstructs or degrades an ability of the imaging sensor 110 to detect objects and features of the environment surrounding the vehicle 100. The occlusion 205 may be a deviation from a depiction of the environment surrounding the vehicle 100, such as something that blocks a field of view of the imaging sensor 110. The occlusion 205 may either be something temporarily physically attached to the vehicle 100 (e.g., a bug or dirt on the imaging sensor 110 or the windshield 210), or a nonsolid feature of the environment through which the vehicle 100 could navigate (e.g., rain, snow, fog, etc.). FIG. 2 shows rain on the windshield 210. The occlusion 205 is not an object or environmental feature that the vehicle 100 would navigate around (i.e., a physical object that is freestanding separate from the vehicle 100).

The computer 105 may store a predetermined set of potential types of occlusions 205. For example, the potential types may include rain in the environment, fog in the environment, snow in the environment, water on the imaging sensor 110 or windshield 210, dirt on the imaging sensor 110 or windshield 210, a bug on the imaging sensor 110 or windshield 210, etc. The predetermined set may include multiple of these potential types (i.e., at least two). The potential types in the predetermined set may be chosen to have visually different appearances and to be addressable by different interventions.

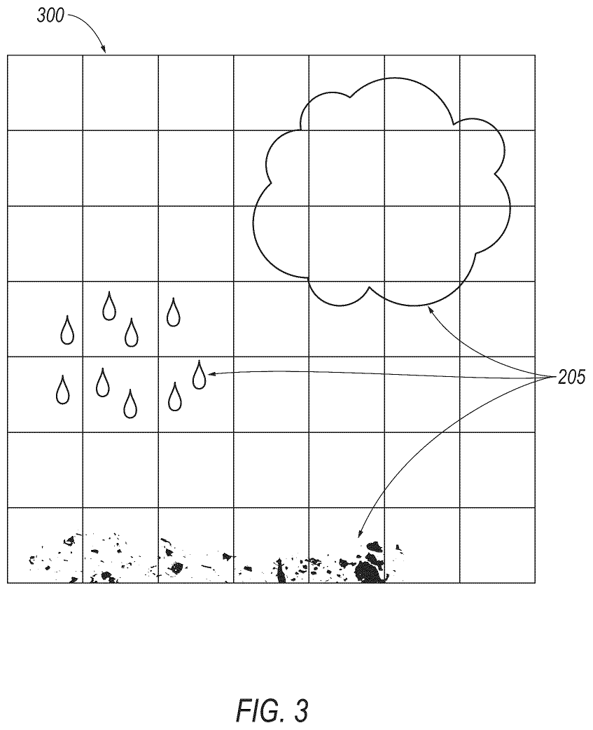

With reference to FIG. 3, the birds-eye view embedding space 300 is a virtual reference frame for localizing the occlusions 205 with respect to the vehicle 100. Where an occlusion 205 is located in the birds-eye view embedding space 300 indicates where the occlusion 205 is located in the environment surrounding the vehicle 100. The birds-eye view embedding space 300 is defined relative to the vehicle 100, so the birds-eye view embedding space 300 moves with the vehicle 100 as the vehicle 100 moves through the environment. The birds-eye view embedding space 300 is a “birds-eye view” in that the birds-eye view embedding space 300 includes data indicating positions as viewed from vertically above looking straight down. In other words, the birds-eye view embedding space 300 includes two horizontal dimensions. For example, the birds-eye view embedding space 300 may be a horizontal plane and lack a vertical dimension. Alternatively, the birds-eye view embedding space 300 may additionally include a vertical dimension. In either two dimensions or three dimensions, the birds-eye view embedding space 300 may be a grid, in other words, subdivided into spaces (i.e., squares or cubes) along the dimensions. The birds-eye view embedding space 300 is an “embedding space” in that the locations of features in the birds-eye view embedding space 300 arise from the operation of the machine-learning techniques described below when given sensor data 405 about the environment.

Where occlusions 205 are in the birds-eye view embedding space 300 is specified with spatial locations. Each spatial location is specified in at least two horizontal dimensions. For example, the spatial location may be specified in two horizontal dimensions if the birds-eye view embedding space 300 is a horizontal plane. For example, the two spatial dimensions may be a longitudinal distance forward from the vehicle 100 and a lateral distance left from the vehicle 100 (with distances to the right indicated as negative numbers). The spatial location may be specified in three spatial dimensions (including the two horizontal dimensions) if the birds-eye view embedding space 300 includes a vertical dimension.

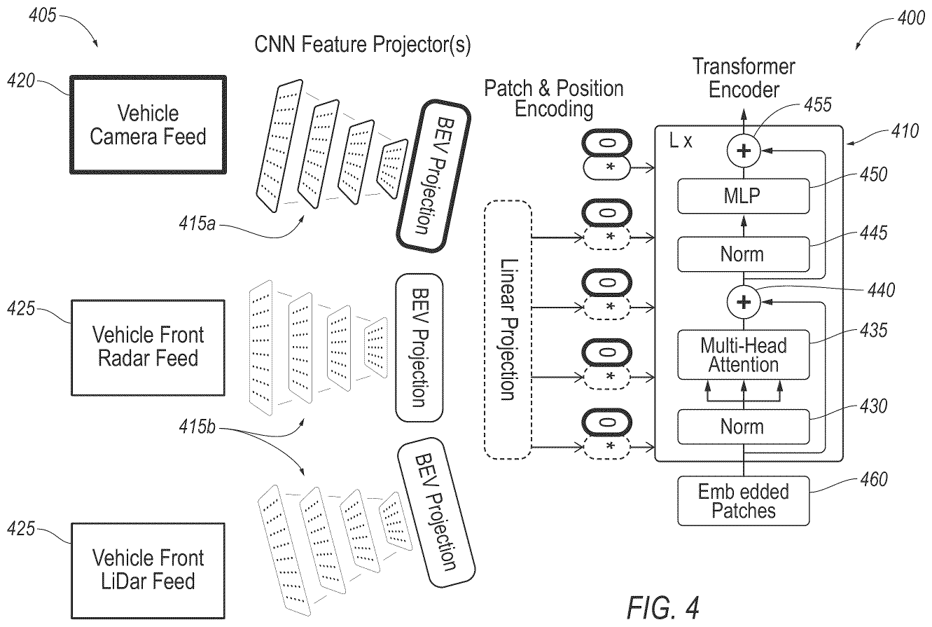

With reference to FIG. 4, the computer 105 may store a machine-learning architecture 400 and may be programmed to execute the machine-learning architecture 400. As a general overview, the machine-learning architecture 400 may include feature projectors 415 and the transformer 410. Each feature projector 415 may receive sensor data 405 from one of the imaging sensors 110, detect features, and determine initial spatial locations corresponding to the features. The feature projectors 415 may include at least one image feature projector 415a and at least one range feature projector 415b (e.g., one image feature projector 415a and two range feature projectors 415b in the example of FIG. 4). The image feature projector 415a takes image data 420 from the camera 120 as input. Each range feature projector 415b takes input from one of the range sensors 125. For example, the range feature projectors 415b may include at least one range feature projector 415b taking input from a radar and at least one range feature projector 415b taking input from a lidar. The use of both radar and lidar for the range data 425 is beneficial because radar typically detects rain while lidar typically sees through rain. The transformer 410 transforms the features from the feature projectors 415 to the birds-eye view embedding space 300, classifies an occlusion 205 from the features, and outputs the spatial location of the occlusion 205.

The sensor data 405 is generated by the imaging sensors 110. For example, the sensor data 405 may include the image data 420 from a camera 120 and the range data 425 from the range sensors 125. The computer 105 may be programmed to receive the sensor data 405 (e.g., over the communications network 115). Each stream of the sensor data 405 from one of the imaging sensors 110 may be an input for a respective one of the feature projectors 415.

The image data 420 includes one or more image frames. Each image frame is a two-dimensional matrix of pixels. Each pixel has a brightness or color represented as one or more numerical values, such as a scalar unitless value of photometric light intensity between 0 (black) and 1 (white), or values for each of red, green, and blue (e.g., each on an 8-bit scale (0 to 255) or a 12- or 16-bit scale). The pixels may be a mix of representations (e.g., a repeating pattern of scalar values of intensity for three pixels and a fourth pixel with three numerical color values, or some other pattern). Position in an image frame (i.e., position in the field of view of the camera 120 at the time that the image frame was recorded) can be specified in pixel dimensions or coordinates (e.g., an ordered pair of pixel distances), such as a number of pixels from a top edge and a number of pixels from a left edge of the image frame.

The range data 425 may be, for example, a point cloud. The points of the point cloud specify respective positions in the environment relative to the position of the range sensor 125. For example, the range data 425 can be in spherical coordinates with the range sensor 125 at the origin of the spherical coordinate system. The spherical coordinates can include a radial distance (i.e., a measured depth from the ranging sensor to the point measured by the ranging sensor); a polar angle (i.e., an angle from a vertical axis through the ranging sensor to the point measured by the ranging sensor); and an azimuthal angle (i.e., an angle in a horizontal plane from a horizontal axis through the ranging sensor to the point measured by the ranging sensor). The horizontal axis can be, for example, along a vehicle-forward direction. Alternatively, the range sensor 125 can return the points as Cartesian coordinates with the range sensor 125 at the origin or as coordinates in any other suitable coordinate system, or the computer 105 can convert the spherical coordinates to Cartesian coordinates or another coordinate system after receiving the range data 425.

The computer 105 is programmed to detect features in the sensor data 405 from the imaging sensors 110. For the purposes of this disclosure, the term “feature” is used in its computer-vision sense as a piece of information about the content of an image or point cloud, specifically about whether a certain region of the sensor data 405 has certain properties. Types of features may include edges, corners, blobs, etc.

For example, the computer 105 may detect the features by executing the respective feature projector 415 for each stream of the sensor data 405. The feature projectors 415 may serve as feature extractors. Each feature projector 415 may include one or more techniques for feature extraction suitable to the type of sensor data 405 (e.g., image, range data 425), such as low-level techniques such as edge detection, corner detection, blob detection, ridge detection, scale-invariant feature transform (SIFT), etc.; shape-based techniques such as thresholding, blob extraction, template matching, Hough transform, generalized Hough transform, etc.; flexible methods such as deformable parameterized shapes, active contours, etc.; etc. The feature projector 415 may include machine-learning operations. For example, the feature projector 415 may include residual network (ResNet) layers followed by a convolutional neural network.

The computer 105 may be programmed to project the features to an initial spatial location of the occlusion 205 in the birds-eye view embedding space 300. For example, the computer 105 may project the features to the initial spatial location by executing the respective feature projector 415 for each stream of the sensor data 405. The feature projector 415 may include any suitable machine-learning techniques for the projection, such as a monocular depth estimator, a multilayer perceptron (MLP), etc. Alternatively, for the image data 420, the computer 105 may apply a predefined geometric relationship mapping the image plane to the ground plane. The geometric relationship may be a homography between the ground plane and the image plane of the camera 120. The term “homography” is used in the projective geometry sense of an isomorphism between projective spaces, in this case the projective space of the ground plane and the projective space of the image plane of the camera 120. In either case, the initial spatial locations may be assigned to points on the grid of the birds-eye view embedding space 300.

The computer 105 may be programmed to rasterize the range data 425 before the transformer 410 fuses the features from the image data 420 and the range data 425 (as described below). The computer 105 may rasterize the range data 425 by executing the respective feature projector 415 for each stream of range data 425 from a range sensor 125 (e.g., for radar data and for lidar data as shown in the example of FIG. 4). The term “rasterize” is used in its graphics sense as a process of converting spatial data to a grid of pixels or voxels. In this case, the grid can be the birds-eye view embedding space 300. The computer 105 may use any suitable rasterization algorithm for sampling the range data 425 to determine the values of the pixels of the grid.

The computer 105 is programmed to execute the transformer 410 on the features returned by the feature projectors 415. The features may include the respective initial spatial locations specified within the grid of the birds-eye view embedding space 300. The transformer 410 transforms the features to the birds-eye view embedding space 300, classifies any occlusions 205 from the features, and outputs the spatial locations of the occlusions 205. As an output, the transformer 410 provides classifications of the occlusions 205 and spatial positions of the occlusions 205 in the birds-eye view embedding space 300. In the example of FIG. 3, the output includes dirt on the windshield 210 (at the lower boundary of the birds-eye view embedding space 300), rain forward of the vehicle 100 on the left side, and fog further forward of the vehicle 100 on the right side. The transformer 410 selects the types for classifying the occlusions 205 from the predetermined set of potential types. The transformer 410 is programmed to fuse the features from the image feature projector 415a with the range data 425 from at least one range sensor 125 (e.g., as outputted by one or more of the range feature projectors 415b) in the birds-eye view embedding space 300. The spatial locations outputted by the transformer 410 represent a fusion of the initial spatial locations of corresponding features and/or rasterized point clouds from the different feature projectors 415.

As a general overview of the structure of the transformer 410, the transformer 410 may include a fixed number L of transformer layers (indicated by “L x” in FIG. 4). The number L of transformer layers can be chosen to balance fast convergence and processing time with accurate detection of the features. Each transformer layer may include (e.g., consist of) a first norm layer 430, a multi-head attention layer 435, a first summation block 440, a second norm layer 445, a multilevel perceptron (MLP) 450, and a second summation block 455 (e.g., in that order). The transformer 410 is programmed to correct the initial spatial location of the occlusion 205 (e.g., received from the image feature projector 415a) with the range data 425 (e.g., from the range feature projectors 415b) to the spatial location, as outputted by the final transformer layer. Each execution of one of the transformer layers refines (i.e., further corrects) the spatial locations.

The features from the feature projectors 415 may be subdivided into a plurality of embedded patches 460 that are then provided as the input to the transformer 410. For example, the features may be subdivided into regions according to the corresponding initial spatial locations. The size of the embedded patches 460 may be chosen to facilitate fast processing time while encompassing enough area to allow identification of the type of occlusion 205. The embedded patches 460 may speed up execution of the transformer 410 and preserve spatial data during execution of the transformer 410.

The first norm layer 430 receives either the features and initial spatial locations from one of the feature projectors 415 (e.g., for the image data 420 from the image feature projector 415a) or the output of the second summation block 455 from the previous transformer layer. The first norm layer 430 performs normalization. The term “normalization” is used in its statistical and machine-learning sense of converting data to conform to specific statistical properties. The first norm layer 430 applies layer normalization across the received data and outputs the converted data to the multi-head attention layer 435.

The multi-head attention layer 435 may use cross-attention or self-attention. A multi-head self-attention layer (MHSA) applies an attention mechanism multiple times in parallel to the input. Colloquially, an MHSA makes the elements of the input aware of other contextual information from the input. A multi-head cross-attention layer (MHCA) takes a function of the input as a query (i.e., the normed data from the image feature projector 415a) and takes a function of the range data 425 from the range feature projectors 415b as the candidate pool. The candidate pool serves as the key and value for the MHCA. The MHCA applies an attention mechanism between the query and the candidate pool multiple times in parallel. Colloquially, the MHCA collects information from the range data 425 to update the features from the image data 420.

The first summation block 440 calculates a sum of the output of the multi-head attention layer 435 and the input to the first norm layer 430. The first summation block 440 represents a skip connection.

The second norm layer 445 receives the output of the first summation block 440. The second norm layer 445 performs normalization. The second norm layer 445 applies layer normalization across the received data and outputs the converted data to the MLP 450.

The MLP 450 is a feedforward artificial neural network (ANN) that is fully connected. The MLP 450 receives the output of the second norm layer 445 as input, and the MLP 450 outputs an updated version of the features with updated spatial locations.

The second summation block 455 calculates a sum of the output of the MLP 450 and the output of the first summation block 440. The second summation block 455 represents a skip connection. Before the execution of the final transformer layer, the output of the second summation block 455 serves as the input to the first norm layer 430 for the execution of the next transformer layer. Upon the execution of the final transformer layer, the output of the second summation block 455 is the output of the transformer 410.

The transformer 410 is trained to classify occlusions 205 into types and to determine the spatial locations of the occlusions 205. The transformer 410 may be trained on training data including streams of features with initial spatial locations from the feature projectors 415 paired with ground-truth classifications and ground-truth spatial locations. For example, labels indicating the ground-truth classifications and/or the ground-truth spatial locations may be manually coded. The ground-truth classifications are chosen from the predetermined set of potential types. Accordingly, the transformer 410 is not trained to classify objects, as objects are not included in the predetermined set of potential types. The transformer 410 may be trained by any suitable training algorithm, such as backpropagation with an optimization algorithm such as gradient descent applied to an objective function. For example, the objective function may be an L2 loss.

The computer 105 may be programmed to actuate a component 130 based on the output of the transformer 410. As one example, the computer 105 may actuate the component 130 of the vehicle 100 based on the classification of the occlusion 205. For example, the computer 105 may actuate the windshield wipers in response to the classification being rain. For another example, the computer 105 may actuate the climate-control system to blow hot air across the windshield 210 in response to the classification being snow in the environment or ice on the windshield 210. For another example, the computer 105 may actuate an air nozzle aimed at the imaging sensor 110 in response to the classification being a bug on the imaging sensor 110. For another example, the computer 105 may actuate a pump or valve controlling washer fluid to a fluid nozzle in response to the classification being dirt or dust on the imaging sensor 110.

Alternatively or additionally, the computer 105 may actuate the component 130 of the vehicle 100 based on the spatial location of the occlusion 205. For example, the computer 105 may select one or a subset of nozzles to actuate from multiple nozzles aimed at the imaging sensor 110 based on the spatial location of the occlusion 205 that is on the imaging sensor 110. For another example, the computer 105 may actuate the windshield wipers at a slower or less frequent speed in response to the occlusion 205 covering a portion of the windshield 210 and at a faster or more frequent speed in response to the occlusion 205 covering all of the windshield 210. For another example, the computer 105 may actuate the windshield wipers once the vehicle 100 is within a threshold distance of the occlusion 205 in the environment.

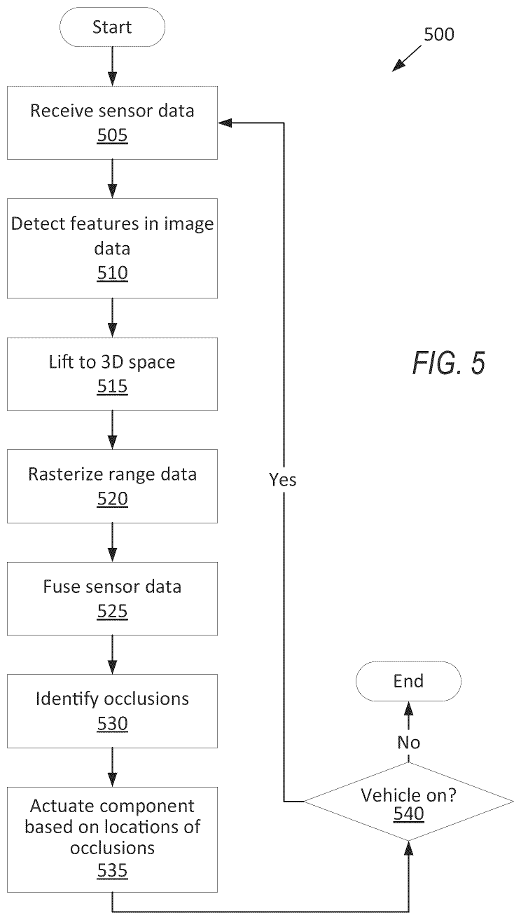

FIG. 5 is a flowchart illustrating an example process 500 for analyzing the occlusions 205 and actuating the components 130. The memory of the computer 105 stores executable instructions for performing the steps of the process 500 and/or programming can be implemented in structures such as mentioned above. As a general overview of the process 500, the computer 105 receives the sensor data 405 from the imaging sensors 110, detects the features in the sensor data 405, projects the features to the birds-eye view embedding space 300, rasterizes the range data 425, fuses the sensor data 405, classifies the occlusions 205, and actuates the components 130 of the vehicle 100. The process 500 continues for as long as the vehicle 100 remains on.

The process 500 begins in a block 505, in which the computer 105 receives the sensor data 405 from the imaging sensors 110, as described above.

Next, in a block 510, the computer 105 detects the features in the sensor data 405, as described above with respect to the feature projectors 415.

Next, in a block 515, the computer 105 projects the features to initial spatial locations in the birds-eye view embedding space 300, as described above with respect to the feature projectors 415.

Next, in a block 520, the computer 105 rasterizes the range data 425 from the range feature projectors 415b, as described above.

Next, in a block 525, the computer 105 fuses the sensor data 405 by executing the transformer 410, as described above.

Next, in a block 530, the computer 105 classifies the occlusions 205 by executing the transformer 410, as described above.

Next, in a block 535, the computer 105 actuates the component 130 of the vehicle 100 based on at least one of the classification of the occlusion 205 or the spatial location of the occlusion 205, as described above.

Next, in a decision block 540, the computer 105 determines whether the vehicle 100 is on (i.e., is in an on state). For the purposes of this disclosure, “on state” is defined as the state of the vehicle 100 in which full electrical energy is provided to electrical components of the vehicle 100 and the vehicle 100 is ready to be driven (e.g., the engine is running); “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to operate the vehicle 100, puts the vehicle 100 into the off state when the operator is going to leave the vehicle 100, and puts the vehicle 100 into the accessory-power state when the operator is going to sit in but not operate the vehicle 100. In response to the vehicle 100 being in the on state, the process 500 returns to the block 505 to continue receiving the sensor data 405. In response to the vehicle 100 transitioning to the off state or accessory-power state, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
detect features in sensor data from an imaging sensor; and
execute a transformer on the features, the transformer transforming the features to a birds-eye view embedding space, classifying an occlusion from the features, and outputting a spatial location of the occlusion;
wherein the transformer is trained to classify occlusions and is not trained to classify objects.

2. The computer of claim 1, wherein the instructions further include instructions to actuate a component based on the spatial location of the occlusion.

3. The computer of claim 2, wherein a vehicle includes the imaging sensor and the component.

4. The computer of claim 1, wherein the instructions further include instructions to actuate a component based on the classification of the occlusion.

5. The computer of claim 1, wherein the imaging sensor is a camera, and the sensor data is image data.

6. The computer of claim 5, wherein the transformer is programmed to fuse the features from the image data with range data from at least one range sensor in the birds-eye view embedding space.

7. The computer of claim 6, wherein the instructions further include instructions to project the features to an initial spatial location of the occlusion in the birds-eye view embedding space, and the transformer is programmed to correct the initial spatial location of the occlusion with the range data to the spatial location.

8. The computer of claim 6, wherein the instructions further include instructions to rasterize the range data before the transformer fuses the features and the range data.

9. The computer of claim 6, wherein the at least one range sensor includes at least one of a lidar or a radar.

10. The computer of claim 6, wherein the at least one range sensor includes a lidar and a radar.

11. The computer of claim 1, wherein the spatial location is specified in at least two horizontal dimensions.

12. The computer of claim 1, wherein the instructions to classify the occlusion include instructions to select a type from a predetermined set of potential types.

13. The computer of claim 12, wherein the predetermined set of potential types includes at least two of rain, fog, dirt on the imaging sensor, or bug on the imaging sensor.

14. A method comprising:
detecting features in sensor data from an imaging sensor; and
executing a transformer on the features, the transformer transforming the features to a birds-eye view embedding space, classifying an occlusion from the features, and outputting a spatial location of the occlusion;
wherein the transformer is trained to classify occlusions and is not trained to classify objects.

15. The method of claim 14, further comprising actuating a component based on the spatial location of the occlusion, wherein a vehicle includes the imaging sensor and the component.

16. The method of claim 14, further comprising actuating a component based on the classification of the occlusion, wherein a vehicle includes the imaging sensor and the component.

17. The method of claim 14, wherein the transformer is programmed to fuse the features with range data from at least one range sensor in the birds-eye view embedding space.

18. The method of claim 17, wherein the transformer is programmed to correct the spatial location of the occlusion with the range data.

19. The method of claim 17, further comprising rasterizing the range data before the transformer fuses the features and the range data.

20. The method of claim 14, wherein classifying the occlusion includes selecting a type from a predetermined set of potential types, and the predetermined set of potential types includes at least two of rain, fog, dirt on the imaging sensor, or bug on the imaging sensor.
